(19) United States
(12) Patent Application Publication
(10) Pub. No.: US 2015/0131265 A1
(43) Pub. Date: May 14, 2015

(54) LIGHT FLUX CONTROLLING MEMBER, LIGHT-EMITTING DEVICE, SURFACE LIGHT SOURCE DEVICE AND DISPLAY APPARATUS

(71) Applicant: Enplas Corporation, Saitama (JP)

(72) Inventor: Masato NAKAMURA, Saitama (JP)

(21) Appl. No.: 14/535,605

(22) Filed: Nov. 7, 2014

(30) Foreign Application Priority Data
Nov. 8, 2013 (JP) 2013-232056

(51) Int. Cl. F21V 7/00; G02F 1/01; F21V 13/02

(52) U.S. Cl. CPC F21V 7/0025; F21V 13/02; G02F 1/0105
USPC 362/97.1; 362/297; 362/346

(57) ABSTRACT

Light flux controlling member (300) includes: first main surface (310) having first incidence surface (313) and second incidence surface (314); second main surface (320) having total reflection surface (321); and side surface (330) that outputs light reflected by total reflection surface (321). First incidence surface (313) is a recessed surface disposed at a center portion of first main surface (310). Second incidence surface (314) is a surface laterally extending from an opening edge of first incidence surface (313). Total reflection surface (321) is a substantially cone-shaped recessed surface having a vertex at a position that faces a vertex of first incidence surface (313).

### CROSS REFERENCE TO RELATED APPLICATIONS

This application is entitled and claims the benefit of Japanese Patent Application No. 2013-232056, filed on Nov. 8, 2013, the disclosure of which including the specification, drawings and abstract is incorporated herein by reference in its entirety.

### TECHNICAL FIELD

The present invention relates to a light flux controlling member that controls the distribution of light emitted from a light emitting element. In addition, the present invention relates to a light-emitting device, a surface light source device and a display apparatus which include the light flux controlling member.

### BACKGROUND ART

Some transmission type image display apparatuses such as liquid crystal display apparatuses use a direct surface light source device as a backlight. In recent years, direct surface light source devices having a plurality of light emitting elements as the light source have been used (see, for example, PTL 1).

FIGS. 1A and 1B illustrate a configuration of surface light source device 10 disclosed in PTL 1. FIG. 1A is a perspective view of surface light source device 10, and FIG. 1B is a partially enlarged sectional view of surface light source device 10. It is to be noted that, in FIG. 1A, some parts of light diffusion member 15 are omitted in order to illustrate the inside of the device.

As illustrated in FIGS. 1A and 1B, surface light source device 10 includes casing 11, support plate 12 disposed in the casing, a plurality of mounting boards 13 fixed on support plate 12, a plurality of light source units 14 fixed on mounting board 13, and light diffusion member 15 disposed at the opening of casing 11. The surfaces of support plate 12 and mounting board 13 are painted in white for the purpose of reflecting light. Light source unit 14 includes LED 16, and optical device 20 that controls the distribution of light emitted by LED 16. Light source unit 14 is fixed on the mounting board 13 with spacer 17 therebetween.

Optical device 20 includes planar-shaped incidence surface 21 formed on the rear side, bell-shaped reflecting surface 22 formed on the front side, and side surface 23 that is formed in such a manner as to connect the outer edge of incidence surface 21 and the outer edge of reflecting surface 22 together. The light emitted from LED 16 enters optical device 20 from incidence surface 21, and is reflected at reflecting surface 22 toward side surface 23. The reflected light is emitted out of optical device 20 from side surface 23. Part of the light emitted from side surface 23 travels toward light diffusion member 15, and other part of the light emitted from side surface 23 travels toward support plate 12 or mounting board 13. The light having reached support plate 12 or mounting board 13 is reflected by the surface of light support plate 12 or mounting hoard 13 while being diffused. The light having reached light diffusion member 15 from side surface 23 and the light having reached light diffusion member 15 from support plate 12 or mounting board 13 are transmitted through light diffusion member 15 while being diffused.

### CITATION LIST

### Patent Literature

### PTL 1

Japanese Patent Application Laid-Open No. 2007-048883

### SUMMARY OF INVENTION

### Technical Problem

However, since the shape of incidence surface 21 of optical device 20 is not optimized in accordance with reflecting surface 22 in surface light source device 10 disclosed in PTL 1, leaked light may be caused at the center portion of reflecting surface 22 and luminance unevenness may be caused. In addition, since the pitch of optical device 20 is not adjusted in accordance with the light distribution characteristics of optical device 20 in surface light source device 10 disclosed in PTL 1, luminance unevenness may be caused. In this regard, optical device 20 and surface light source device 10 disclosed in PTL 1 have a room for improvement in reducing luminance unevenness. In addition, since surface light source device 10 disclosed in PTL 1 is not designed such that light is incident on an optimum position of light diffusion member 15 at an optimum angle, the amount of wasted light is large.

An object of the present invention is to provide a light flux controlling member configured to control the distribution of the light emitted from a light emitting element, which can reduce luminance unevenness, and can improve light use efficiency by allowing light to be incident on an optimum portion of a light diffusion member at an optimum angle when it is used in a surface light source device. In addition, anther object of the present invention is to provide a light-emitting device, a surface light source device and a display apparatus which include the light flux controlling member.

### Solution to Problem

To achieve the above-mentioned object, a light flux controlling member according to an embodiment of the present invention that controls a distribution of light emitted from a light emitting element includes: a first main surface including a first incidence surface on which part of light emitted from the light emitting element is incident and a second incidence surface on which the other part of the light emitted from the light emitting element is incident; a second main surface disposed at a position opposite to the first main surface, the second main surface including a total reflection surface configured to laterally reflect light incident on the first incidence surface and light incident on the second incidence surface; a side surface disposed in such a manner as to connect an outer edge of the first main surface and an outer edge of the second main surface, the side surface being configured to output light reflected by the total reflection surface, wherein the first incidence surface is a recessed surface disposed at a center portion of the first main surface, the second incidence surface is a surface laterally extending from an opening edge of the first incidence surface, and the total reflection surface is a recessed surface having a substantially cone shape, the total reflection surface including a vertex disposed at a position that faces a vertex of the first incidence surface.

A light-emitting device according to an embodiment of the present invention includes: a light emitting element; and the light flux controlling member according to the embodiment of the present invention disposed in such a manner that an optical axis of the light emitting element passes the vertex of the first incidence surface, wherein, when a direction of the optical axis is set to 0 degree, a peak angle of a relative luminous intensity in a light distribution is greater than 90 degrees, and light emitted at an angle equal to or greater than 90 degrees with respect to the optical axis is, substantially, light that is incident on the second incidence surface, is reflected by the total reflection surface, and is output from the side surface.

A surface light source device according to an embodiment of the present invention includes: a diffusion-and-reflection surface; a plurality of the light-emitting devices according to the embodiment of the present invention that are disposed on the diffusion-and-reflection surface; and a light diffusion member that allows light emitted from the light-emitting devices to pass therethrough while diffusing the light emitted from the light-emitting devices, wherein, in a cross section including optical axes of adjacent two light-emitting devices, light which is emitted from a light emission center of the light emitting element of one of the adjacent two light-emitting devices, reflected at an upper end part of the total reflection surface on the other of the adjacent two light-emitting devices side, and output from the side surface reaches a position between the two adjacent light-emitting devices on the diffusion-and-reflection surface.

A display apparatus according to an embodiment of the present invention includes a surface light source device according to an embodiment of the present invention, and a display member configured to be irradiated with light emitted from the surface light source device.

### Advantageous Effects of Invention

In comparison with a surface light source device having a conventional light flux controlling member, the surface light source device having the light flux controlling member according to the embodiment of the present invention can uniformly and efficiently irradiate the surface to be illuminated. Accordingly, the surface light source device and the display apparatus according to the embodiment of the present invention is bright and reduces luminance unevenness in comparison with the conventional apparatus.

### BRIEF DESCRIPTION OF DRAWINGS

FIGS. 1A and 1B illustrate a configuration of the surface light source device disclosed in PTL 1;

FIGS. 2A and 2B illustrate a configuration of a surface light source device according to an embodiment;

FIGS. 3A and 3B arc sectional views illustrating the configuration of the surface light source device according to the embodiment;

FIG. 4 is a partially enlarged sectional view of FIG. 3B;

FIGS. 5A to 5C illustrate a configuration of a light flux controlling member according to the embodiment;

FIG. 6 is a sectional view illustrating the configuration of the light flux controlling member according to the embodiment;

FIGS. 7A to 7C illustrate light paths in a light-emitting device according to the embodiment;

FIG. 8 illustrates light paths in the surface light source device according to the embodiment;

FIG. 9 illustrates light paths in the surface light source device according to the embodiment;

FIG. 10 a graph illustrating light distribution characteristics of the light flux controlling member according to the embodiment;

FIGS. 11A and 11B illustrate a configuration of a surface light source device used for measuring a luminance distribution; and

FIGS. 12A and 12B are graphs illustrating the luminance distribution of the surface light source device illustrated in FIGS. 11A and 11B.

### DESCRIPTION OF EMBODIMENT

In the following, an embodiment of the present invention will be described in detail with reference to the accompanying drawings. Here, as a typical example of the surface light source device of the embodiment of the present invention, a surface light source device suitable as a backlight of a liquid crystal display apparatus will be described. When used with a member (for example, liquid crystal panel) to be irradiated with light from surface light source device, the surface light source device can be used as a display apparatus.

### (Configurations of Surface Light Source Device and Light-Emitting Device)

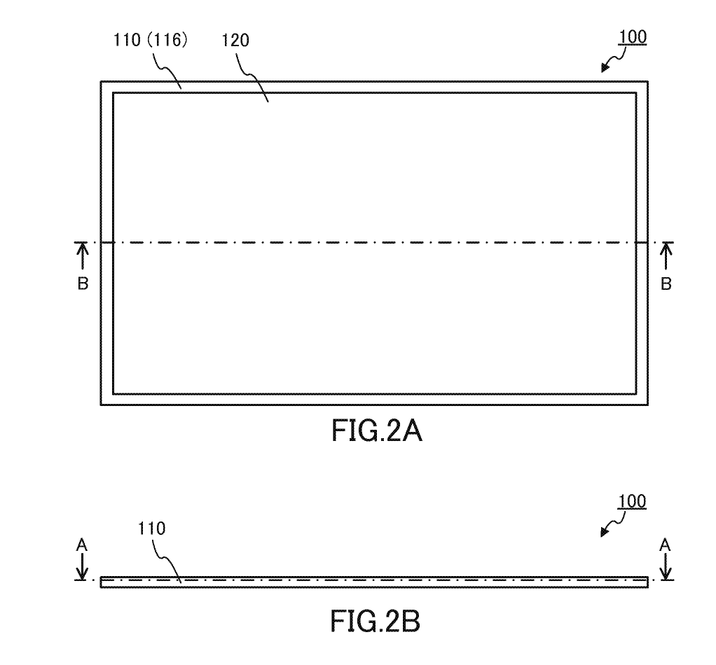

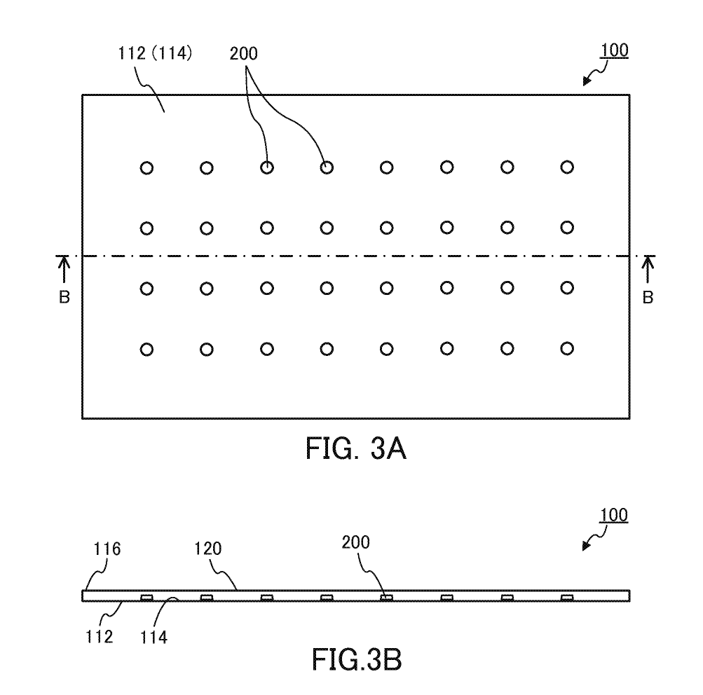

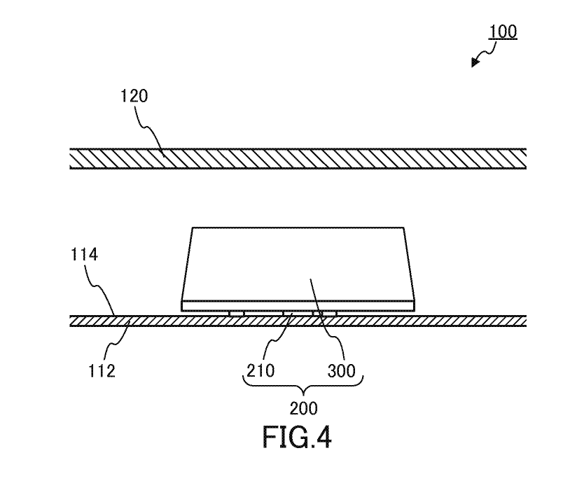

FIGS. 2A and 2B, FIGS. 3A and 3B and FIG. 4 illustrate a configuration of surface light source device 100 according to the embodiment of the present invention. FIG. 2A is a plan view, and FIG. 2B is a front view. FIG. 3A is a sectional view taken along line A-A of FIG. 2B, and FIG. 3B is a sectional view taken along line B-B of FIG. 2A. FIG. 4 is an enlarged sectional view illustrating a part of FIG. 3B.

As illustrated in FIG. 2A to FIG. 3B, surface light source device 100 according to the embodiment includes casing 110, a plurality of light-emitting devices 200 and light diffusion member 120. Light-emitting devices 200 are disposed on internal surface 114 of bottom plate 112 of casing 110 in a matrix. Internal surface 114 of bottom plate 112 functions as a diffusion-and-reflection surface. In addition, top plate 116 of casing 110 is provided with an opening. Light diffusion member 120 is disposed in such a manner as to cover the opening, and functions as a light emitting surface. The size of light emitting surface is, but not limited to, about 400 mm×about 700 mm, for example.

As illustrated in FIG. 4, each light-emitting device 200 is fixed on diffusion-and-reflection surface 114. Each light-emitting device 200 includes light emitting element 210 and light flux controlling member 300.

Light emitting element 210 is a light source of surface light source device 100. Light emitting element 210 is a light-emitting diode (LED) such as a white light-emitting diode, for example.

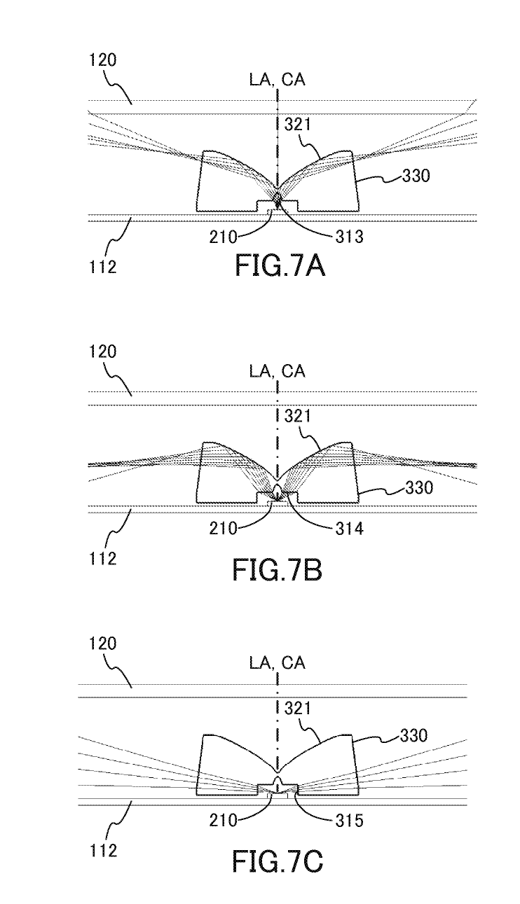

Light flux controlling member 300 controls the distribution of the light emitted from light emitting element 210. Light flux controlling member 300 is disposed over light emitting element 210 in such a manner that its central axis CA matches optical axis LA of light emitting element 210 (see FIGS. 7A to 7C). It is to be noted that, in the embodiment, first incidence surface 313, second incidence surface 314, third incidence surface 315, total reflection surface 321 and side surface 330 of light flux controlling member 300 are each rotationally symmetric (circularly symmetric), and their rotational axes match each other. In the embodiment, the rotational axis is referred to as “central axis CA of light flux controlling member.” In addition, the term “optical axis LA of light emitting element” means the central light beam of a stereoscopic emission light flux from light emitting element 210. Between the internal surface of bottom plate 112 (diffusion-and-reflection surface 114) and light flux controlling member 300, a gap for releasing heat emitted from light emitting element 210 to outside is defined.

Light flux controlling member 300 is formed by integral molding. The material of light flux controlling member 300 is not particularly limited as long as the light having a desired wavelength can pass through the material. Examples of the material of light flux controlling member 100 include: light transmissive resins such as polymethylmethacrylate (PMMA), polycarbonate (PC), and epoxy resin (EP); or glass.

Surface light source device 100 according to the embodiment is characterized by the configuration of light flux controlling member 300. Therefore, light flux controlling member 300 will be separately described in detail.

Light diffusion member 120 is a plate-shaped member having a light diffusing property, and allows the light emitted from light-emitting device 200 to pass therethrough while diffusing the light. Normally, the size of light diffusion member 120 is substantially the same as that of the member to be irradiated, such as a liquid crystal panel. For example, light diffusion member 120 is formed of light transmissive resins such as polymethylmethacrylate (PMMA), polycarbonate (PC), polystyrene (PS), and styrene methyl methacrylate copolymerization resin (MS). In order to provide a light diffusing property, minute irregularities are formed on the surface of light diffusion member 120, or diffusing members such as beads are dispersed in light diffusion member 120.

### (Configuration of Light Flux Controlling Member)

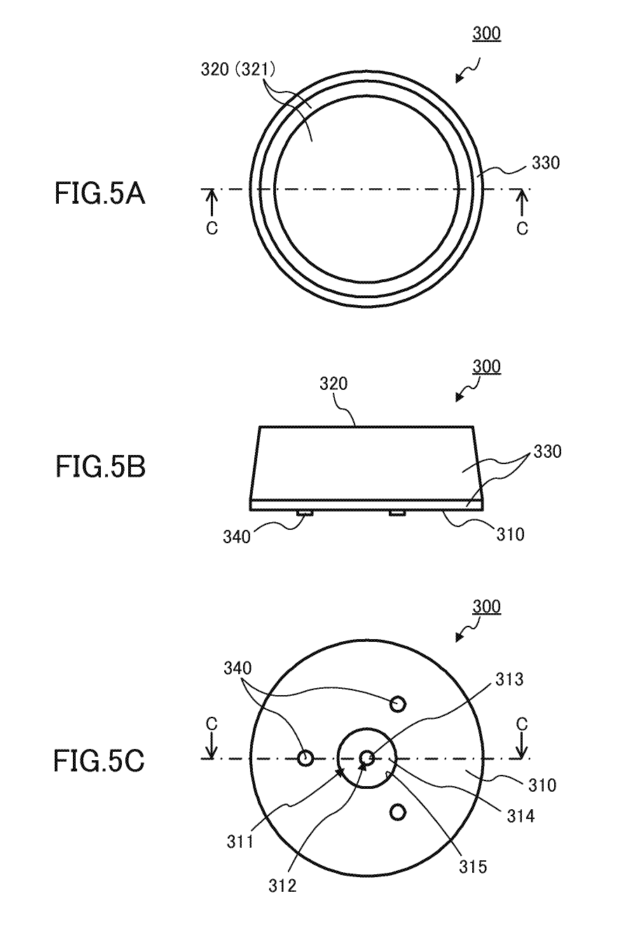

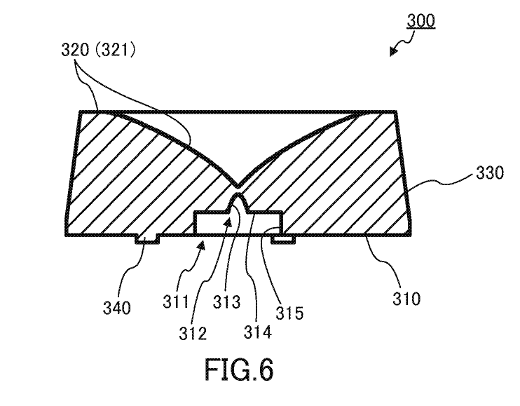

FIGS. 5A to 5C and FIG. 6 illustrate a configuration of light flux controlling member 300 according to the embodiment. FIG. 5A is a plan view, FIG. 5B is a front view, and FIG. 5C is a bottom view. FIG. 6 is a sectional view taken along line C-C of FIG. 5A and FIG. 5C.

As illustrated in FIGS. 5A to 5C and FIG. 6, light flux controlling member 300 includes first main surface 310 located on bottom plate 112 side (rear side), second main surface 320 located on light diffusion member 120 side (front side), side surface 330 located on the side plate side of casing 110, and a plurality of leg parts 340 disposed on bottom plate 112 side (rear side). Assuming that leg parts 340 are not provided, first main surface 310, second main surface 320 and side surface 330 are each rotationally symmetric (circularly symmetric), and their rotational axes match each other.

First main surface 310 is disposed on the rear side of light flux controlling member 300, and includes first incidence surface 313, second incidence surface 314 and third incidence surface 315. These incidence surfaces are described in detail. First recess 311 having a cylindrical shape is formed at a center portion of first main surface 310, and further, second recess 312 having a shape like a prolate hemispheroid is formed at a center portion first recess 311. The internal surface of second recess 312 functions as first incidence surface 313 on which part of the light emitted from light emitting element 210 falling within a region of small angles with respect to central axis CA is incident. In addition, the bottom surface of first recess 311 is a plane perpendicular to the optical axis of light emitting element 210, and functions as second incidence surface 314 on which the light emitted from light emitting element 210 falling within a region of larger angles than the angles of the light incident on first incidence surface 313 with respect to central axis CA is incident. The side surface of first recess 311 is a curved surface in parallel with optical axis of light emitting element 210, and functions as third incidence surface 315 on which the light emitted from light emitting clement 210 falling within a region of larger angles than the angles of the light incident on second incidence surface 314 with respect to central axis CA is incident. First incidence surface 313, second incidence surface 314 and third incidence surface 315 are surfaces rotationally symmetrical (circularly symmetrical) about central axis CA.

It is also possible to directly form second recess 312 at a center portion of first main surface 310 without forming first recess 311. In this case, the internal surface of second recess 312 serves as first incidence surface 313, a plane laterally extending from the opening edge of second recess 312 serves as second incidence surface 314, and third incidence surface 315 is not provided. In any case, first incidence surface 313 is a recessed surface disposed at a center portion of first main surface 310. Second incidence surface 314 is a surface laterally extending from the opening edge of first incidence surface 313.

Second main surface 320 is disposed on the front side of light flux controlling member 300, and includes total reflection surface 321. Second main surface 320 is disposed at a position opposite to first main surface 310. Total reflection surface 321 laterally reflects the light incident on first incidence surface 313 and second incidence surface 314. Total reflection surface 321 is a recessed surface having a substantially cone shape and includes a vertex at a position facing the vertex of first incidence surface 313.

Total reflection surface 321 is a surface rotationally symmetrical (circularly symmetrical) about central axis CA of light flux controlling member 300. In addition, as illustrated in FIG. 6, the generatrix ranging from the center to the outer periphery of the rotationally symmetrical surface is a recessed curve with respect to light emitting element 210 and first main surface 310, and total reflection surface 321 is a surface which is obtained by rotating the generatrix 360 degrees. Total reflection surface 321 is a curved surface having an aspherical shape whose height from light emitting element 210 increases toward the outer periphery from the center. That is, as viewed in a cross section including central axis CA, total reflection surface 321 includes two curves each bulging in a direction away from light emitting element 210, and the two curves are connected on central axis CA. In total reflection surface 321, the height from light emitting element 210 is lowest at the connecting point of the two curves, and in comparison with the case of a cone shape having a straight generatrix, total reflection surface 321 may be formed in a more acute cone-shaped recessed surface. The inclination angle of total reflection surface 321 with respect to the internal surface of bottom plate 112 (diffusion-and-reflection surface 114) decreases from the center toward the outer periphery. It is to he noted that, while the term “generatrix” generally means a straight line that defines a ruled surface, the term “generatrix” used in the embodiment includes curves for defining total reflection surface 321 which is a rotationally symmetrical surface.

Side surface 330 is disposed in such a manner as to connect the outer edge of first main surface 310 and the outer edge of second main surface 320 together. Side surface 330 outputs the light reflected by total reflection surface 321 and the light incident on third incidence surface 315. Side surface 330 is a surface rotationally symmetrical (circularly symmetrical) about central axis CA. The lower portion of side surface 330 has a shape of a side surface of a cylinder, and the upper portion of side surface 330 has a shape of a side surface of a truncated conical shape. It should be noted that the shape of side surface 330 is not limited to the above-mentioned example, and may be appropriately selected in accordance with the light distribution characteristics required for light flux controlling member 300. For example, the entirety of side surface 330 may be formed in a shape of a side surface of a cylinder shape, or a shape of a side surface of a truncated conical shape.

Leg parts 340 are cylindrical members protruding from first main surface 310. Leg parts 340 support light flux controlling member 300 at an appropriate position for light emitting element 210.

FIGS. 7A to 7C illustrate light paths of light emitted from the light emission center of light-emitting device 200. FIG. 7A illustrates light paths of light beams incident on first incidence surface 313, FIG. 7B illustrates light paths of light beams incident on second incidence surface 314, and FIG. 7C illustrates light paths of light beams incident on third incidence surface 315. It is to be noted that leg parts 340 are omitted in FIGS. 7A to 7C.

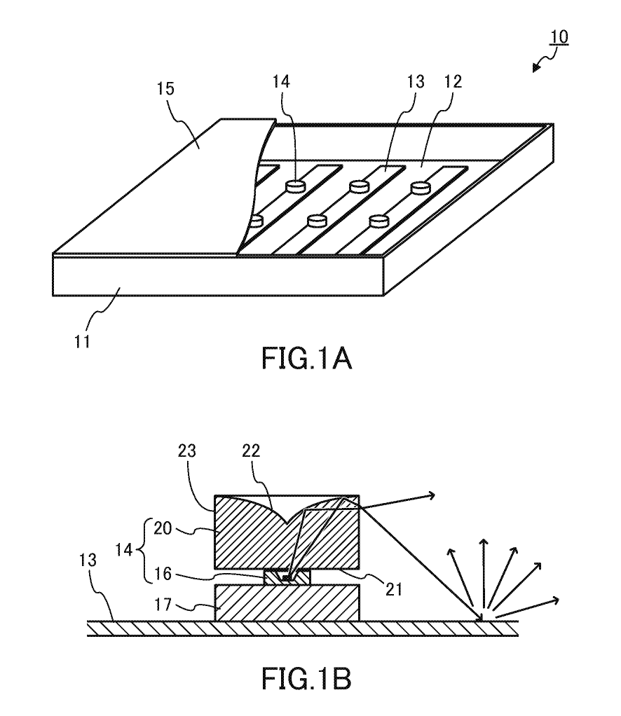

As illustrated in FIG. 7A, the light incident on first incidence surface 313 is expanded at first incidence surface 313 (recessed surface), and reaches a center portion and a portion around the center portion of total reflection surface 321. The light having reached total reflection surface 321 is reflected toward side surface 330, and output from side surface 330. The light output from side surface 330 travels upward, and directly reaches light diffusion member 120. It is to be noted that the light having reached the vertex (center) of total reflection surface 321 may not be reflected at total reflection surface 321 and may be transmitted through total reflection surface 321 (leaked light). However, in light flux controlling member 300 of the embodiment, the light emitted from a center portion of the light emitting surface of light emitting element 210 at a small angle with respect to optical axis LA is refracted at first incidence surface 313, and therefore the amount of light that reaches the vertex (center) of total reflection surface 321 is small, and the amount of the leaked light is also small. In contrast, as illustrated in FIG. 1B, since incidence surface 21 is a plane in optical device 20 disclosed in PTL 1, leaked light is caused at a center portion of reflecting surface 22.

As illustrated in FIG. 7B, the light incident on second incidence surface 314 reaches the center portion and the outer periphery of total reflection surface 321. The light having reached total reflection surface 321 is reflected toward side surface 330, and output from side surface 330. The light output from side surface 330 travels in the horizontal direction and downward direction, and travels toward diffusion-and-reflection surface 114. The light having reached diffusion-and-reflection surface 114 is diffused and reflected at diffusion-and-reflection surface 114, and thus the light reaches light diffusion member 120. Since second incidence surface 314 is a plane perpendicular to optical axis LA in light flux controlling member 300 of the embodiment, the expansion of the light incident on second incidence surface 314 can be narrowed in comparison with the case where second incidence surface 314 is a recessed surface. Accordingly, in light flux controlling member 300 of the embodiment, the effective diameter of total reflection surface 321 can be decreased.

It is to be noted that, in the case where the incidence surface is composed only of a recessed surface as with first incidence surface 313, the amount of light that does not travel toward total reflection surface 321 but directly travels toward side surface 330 increases, and luminance unevenness may be caused. Such a problem may be solved by increasing the effective diameter of total reflection surface 321; however, increasing the effective diameter of total reflection surface 321 is not preferable from the standpoint of downsizing of the light flux controlling member.

As illustrated in FIG. 7C, the light incident on third incidence surface 315 directly travels toward side surface 330, and output from side surface 330. The light output from side surface 330 directly travels toward light diffusion member 120. In the above-mentioned manner, the light emitted from light emitting element 210 at a large angle with respect to optical axis LA which does not require a large angle conversion is controlled so as not to reach total reflection surface 321, and thus the size of light flux controlling member 300 can be further reduced.

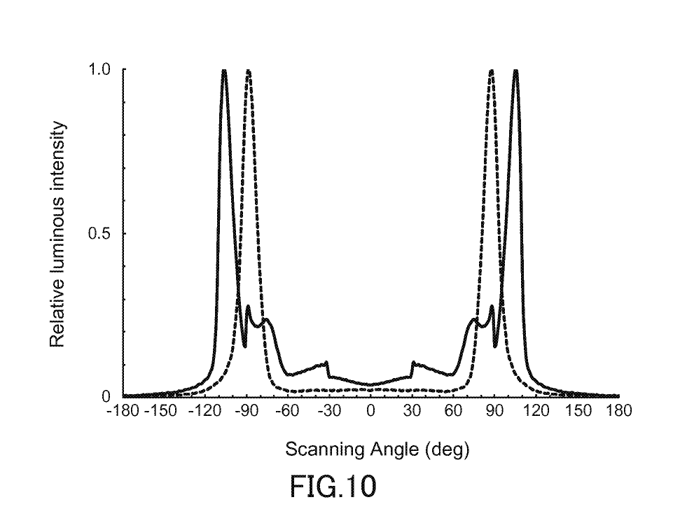

As described, in light flux controlling member 300 of the embodiment, total reflection surface 321 is formed such that the light which is incident on second incidence surface 314, reflected by total reflection surface 321 toward side surface 330, and output from side surface 330 travels in the horizontal direction and downward direction, and therefore, when the direction of optical axis LA is defined as 0 degree, the peak angle of the relative luminous intensity in the light distribution of the light-emitting devices 200 is greater than 90 degrees (see FIG. 10). Substantially, the light emitted from the light-emitting devices 200 at an angle equal to or greater than 90 degrees with respect to optical axis LA is light which is incident on second incidence surface 314, reflected by total reflection surface 321, and output from side surface 330. The shapes of second incidence surface 314 and total reflection surface 321 are adjusted in accordance with the amount of light required for the region between adjacent two light-emitting devices 200.

### (Light Paths in Surface Light Source Device and Pitch of Light-Emitting Device)

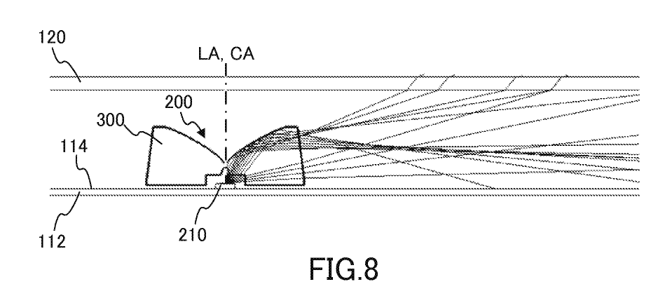

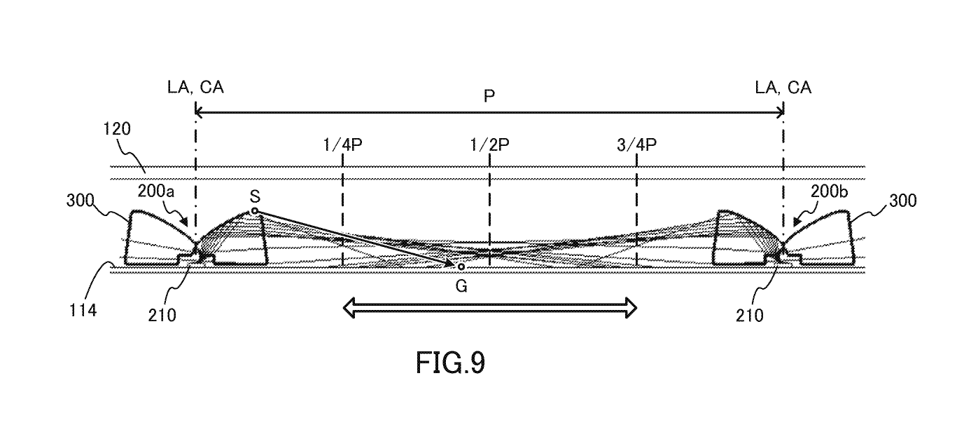

FIG. 8 and FIG. 9 illustrate light paths in surface light source device 100. FIG. 8 illustrates light emitted from one light-emitting device 200, and FIG. 9 illustrate part of light emitted from two light-emitting devices 200 (light incident on second incidence surface 314). FIG. 8 and FIG. 9 illustrate paths of light from a light emission center of light emitting element 210.

As illustrated in FIG. 8, in light-emitting device 200, the light emitted from light emitting element 210 enters light flux controlling member 300 from first incidence surface 313, second incidence surface 314 or third incidence surface 315. As described above, the light incident on first incidence surface 313 is reflected by total reflection surface 321, and output upward from side surface 330. In addition, the light incident on third incidence surface 315 is directly output upward from side surface 330. The above-mentioned upward light directly reaches light diffusion member 120.

On the other hand, the light incident on second incidence surface 314 is reflected by total reflection surface 321, and output from side surface 330 in the horizontal direction and downward direction. The light reaches diffusion-and-reflection surface 114. At this time, as illustrated in FIG. 9, in a cross section including central axes CAs (optical axes LAs) of adjacent two light-emitting devices 200a and 200b, the light reflected at an upper end part on light-emitting device 200b side in total reflection surface 321 of light-emitting device 200a and then output from side surface 330 reaches diffusion-and-reflection surface 114 in a region between light-emitting devices 200a and 200b. To be more specific, in the above-mentioned cross section, of the light which is reflected at an upper end part (“Point S” in FIG. 9) on light-emitting device 200b side of total reflection surface 321 of light-emitting device 200a and output from side surface 330, the light output in a direction of the peak angle θp (which will be described later with reference to FIG. 10; 105 degrees in the embodiment) of the relative luminous intensity in the light distribution of light-emitting device 200a reaches diffusion-and-reflection surface 114 (“Point G” in FIG. 9) in a region at a distance of ¼ to ¾ (indicated by the “outlined arrow” in FIG. 9) from a center of light-emitting device 200a in the center-to-center region of two light-emitting devices 200a and 200b (indicated by “thin arrow P” in FIG. 9). That is, in the cross section, the straight line lined from an upper end part of total reflection surface 321 of light-emitting device 200a as a starting point in the direction of the peak angle θp of the relative luminous intensity in the light distribution of light-emitting device 200a reaches diffusion-and-reflection surface 114 in the region at a distance of ¼ to ¾ from the center of light-emitting device 200a in the center-to-center region of two light-emitting devices 200a and 200b. In other words, a plurality of light-emitting devices 200 are disposed in such a manner as to satisfy the above-mentioned condition. The light having reached diffusion-and-reflection surface 114 is diffused and reflected by diffusion-and-reflection surface 114, before reaching light diffusion member 120 (not illustrated in the drawing).

The light having directly reached light diffusion member 120 from light flux controlling member 300, and the light having reached light diffusion member 120 from diffusion-and-reflection surface 114 are transmitted through light diffusion member 120 while being diffused.

### (Light Distribution Characteristics of Light Flux Controlling Member and Luminance Distribution of Surface Light Source Device)

The light distribution characteristics of light flux controlling member 300 according to the embodiment were measured. In addition, for comparison, light distribution characteristics were measured also in a light flux controlling member for comparison that is designed to bring highly intense light to reach as remote a place as possible in order to prevent a bright point from being caused in the proximity of a light-emitting device in a surface light source device.

FIG. 10 is a graph illustrating the light distribution characteristics of the two different light flux controlling members. The abscissa indicates angles when the center of the light emitting surface of light emitting element 210 is defined as the origin and the optical axis LA of light emitting element 210 is set at 0 degree. The ordinate indicates the relative luminous intensity at each angle. The measured light distribution of the light flux controlling member for comparison is indicated by the broken line, and the measured light distribution of light flux controlling member 300 according to the embodiment is indicated by the solid line. As can be seen in the graph, the peak angle θp of the relative luminous intensity of the light flux controlling member for comparison was equal to or smaller than 90 degrees (88 degrees), whereas the peak angle θp of the relative luminous intensity of light flux controlling member 300 according to the embodiment was greater than 90 degrees (105 degrees). Accordingly, it can be said that light flux controlling member 300 according to the embodiment can generate the light directed toward diffusion-and-reflection surface 114 more than the light flux controlling member for comparison.

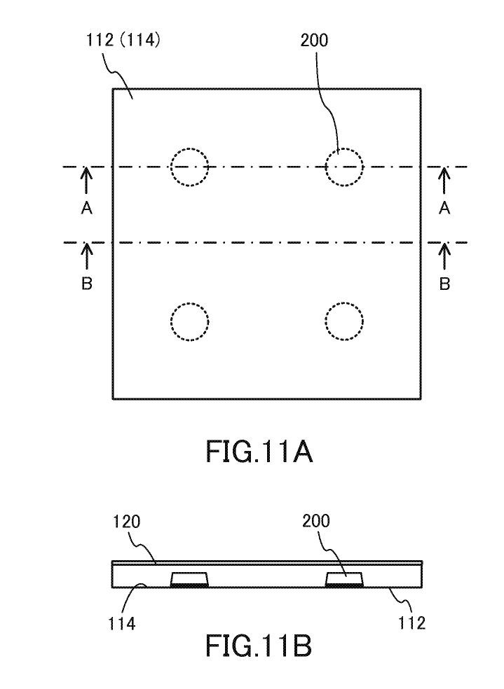

Next, a luminance distribution was measured in the surface light source device provided with light flux controlling member 300 according to the embodiment. In addition, for comparison, a luminance distribution was measured also in a surface light source device provided with the above-mentioned light flux controlling member for comparison. The luminance distributions were measured using the surface light source device illustrated in FIGS. 11A and 11B. FIG. 11A is a plan view of the surface light source device, and FIG. 11B is a sectional view taken along line B-B of FIG. 11A. As illustrated in FIGS. 11A and 11B, the surface light source device used for the measurement is provided with four light-emitting devices 200. The size of bottom plate 112 (diffusion-and-reflection surface 114) is 200 mm×200 mm, and the center-to-center distance between adjacent two light-emitting devices 200 is 100 mm. The distance between diffusion-and-reflection surface 114 and the internal surface of light diffusion member 120 is 15 mm.

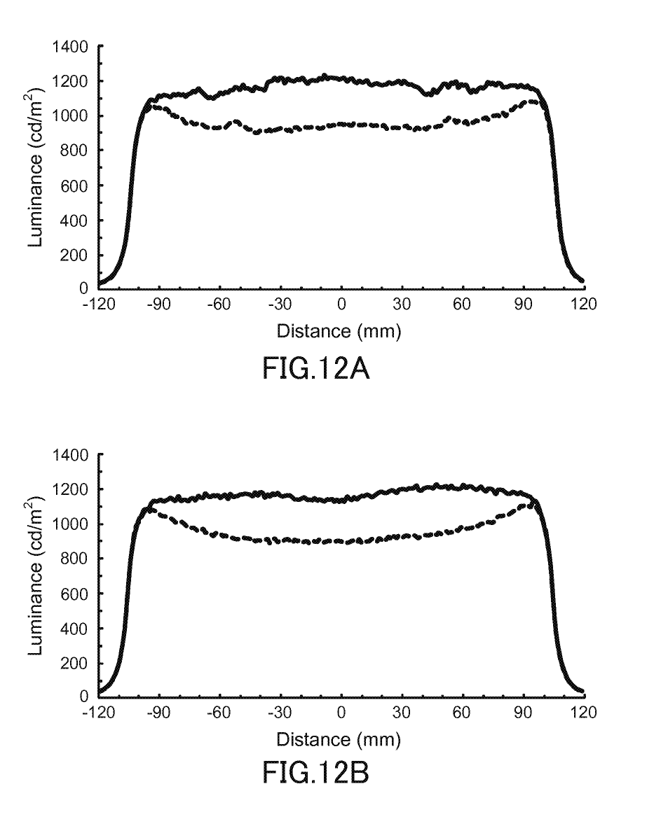

FIGS. 12A and 12B are graphs illustrating the luminance distributions of the surface light source device illustrated in FIGS. 11A and 11B. FIG. 12A is a graph illustrating the luminance distribution on line A-A illustrated in FIG. 11A, and FIG. 12B is a graph illustrating the luminance distribution on line B-B illustrated in FIG. 11A. In the graphs, the abscissa indicates the distance from the center. The ordinate indicates the luminance at each point. The measured luminance distribution of the surface light source device provided with the light flux controlling member for comparison is indicated by the broken line, and the measured luminance distribution of the surface light source device provided with light flux controlling member 300 according to the embodiment is indicated by the solid line. As can be seen in the graph, the surface light source device provided with the light flux controlling member for comparison cannot effectively use diffusion-and-reflection surface 114 and causes significant luminance unevenness, whereas the surface light source device provided with light flux controlling member 300 according to the embodiment can effectively use diffusion-and-reflection surface 114 and causes little luminance unevenness. In addition, as illustrated in FIGS. 12A and 12B, the light emitted from the light flux controlling member for comparison has its peak luminous intensity in a 90-degree direction (the direction in parallel with diffusion-and-reflection surface 114) in the light distribution, and therefore it can be said that the amount of light that reaches the side wall of the casing is large while the amount of light that reaches the region between the light-emitting devices is small. In contrast, the light emitted from light flux controlling member 300 according to the embodiment is reflected by diffusion-and-reflection surface 114, and is incident on light diffusion plate 120 at a proper angle (an angle that causes less surface reflection). Thus, as illustrated in FIGS. 12A and 12B, high luminance can be efficiently obtained also in the region between light-emitting devices 200.

As described above, in light flux controlling member 300 according to the embodiment, light is expanded by recessed first incidence surface 313 to reduce the amount of light directed toward the center of total reflection surface 321, and this makes it possible to reduce the amount of the leaked light caused through the center of total reflection surface 321. In addition, in light flux controlling member 300 according to the embodiment, planar second incidence surface 314 is provided around first incidence surface 313, and thus it is possible to prevent the effective diameter of total reflection surface 321 from being increased. That is, light flux controlling member 300 according to the embodiment can limit the generation of leaked light while achieving downsizing.

In light-emitting device 200 provided with light flux controlling member 300 according to the embodiment, the peak angle of the relative luminous intensity is greater than 90 degrees, and therefore light diffusion member 120 can be efficiently and uniformly irradiated with light by effectively using diffusion-and-reflection surface 114. Accordingly, surface light source device 100 according to the embodiment is bright and reduces luminance unevenness.

### INDUSTRIAL APPLICABILITY

The light flux controlling member, the light-emitting device and the surface light source device according to the embodiment of the present invention are applicable to, for example, a backlight of liquid crystal display apparatuses or generally-used illumination apparatuses.

### REFERENCE SIGNS LIST

10 Surface light source device

11 Casing

12 Support plate

13 Mounting board

14 Light source unit

15 Light diffusion member

16 LED

17 Spacer

20 Optical device

21 Incidence surface

22 Reflecting surface

23 Side surface

100 Surface light source device

110 Casing

112 Bottom plate

114 Internal surface (Diffusion-and-reflection surface)

116 Top plate

120 Light diffusion member (Light emitting surface)

200 Light-emitting device

210 Light emitting element

300 Light flux controlling member

310 First main surface

311 First recess

312 Second recess

313 First incidence surface

314 Second incidence surface

315 Third incidence surface

320 Second main surface

321 Total reflection surface

330 Side surface

340 Leg part

CA Light flux controlling member central axis

LA Light emitting element optical axis

P Pitch of light-emitting device

1. A light flux controlling member that controls a distribution of light emitted from a light emitting element, the light flux controlling member comprising:
a first main surface including a first incidence surface on which part of light emitted from the light emitting element is incident and a second incidence surface on which the other part of the light emitted from the light emitting element is incident;
a second main surface disposed at a position opposite to the first main surface, the second main surface including a total reflection surface configured to laterally reflect light incident on the first incidence surface and light incident on the second incidence surface;
a side surface disposed in such a manner as to connect an outer edge of the first main surface and an outer edge of the second main surface, the side surface being configured to output light reflected by the total reflection surface, wherein
the first incidence surface is a recessed surface disposed at a center portion of the first main surface,
the second incidence surface is a surface laterally extending from an opening edge of the first incidence surface, and
the total reflection surface is a recessed surface having a substantially cone shape, the total reflection surface including a vertex disposed at a position that faces a vertex of the first incidence surface.

2. The light flux controlling member according to claim 1, wherein the first incidence surface and the second incidence surface are disposed in a recess defined in the first main surface.

3. The light flux controlling member according to claim 1, wherein a cross section of the total reflection surface including a central axis of the total reflection surface includes a curve bulging in a direction away from the first main surface.

4. A light-emitting device comprising:
a light emitting element; and
the light flux controlling member according to claim 1 disposed in such a manner that an optical axis of the light emitting element passes the vertex of the first incidence surface, wherein,
when a direction of the optical axis is set to 0 degree, a peak angle of a relative luminous intensity in a light distribution of the light-emitting device is greater than 90 degrees, and,
substantially, light emitted from the light-emitting device at an angle equal to or greater than 90 degrees with respect to the optical axis is light which is incident on the second incidence surface, reflected by the total reflection surface, and output from the side surface.

5. A surface light source device comprising:
a diffusion-and-reflection surface;
a plurality of the light-emitting devices according to claim 4 that are disposed on the diffusion-and-reflection surface; and
a light diffusion member that allows light emitted from the light-emitting devices to pass therethrough while diffusing the light emitted from the light-emitting devices, wherein,
in a cross section including optical axes of adjacent two light-emitting devices, light which is emitted from a light emission center of the light emitting element of one of the adjacent two light-emitting devices, reflected at an upper end part of the total reflection surface on the other of the adjacent two light-emitting devices side, and output from the side surface reaches a position between the two adjacent light-emitting devices on the diffusion-and-reflection surface.

6. The surface light source device according to claim 5, wherein, in the cross section, a straight line lined from the upper end part of the total reflection surface as a starting point in a direction of a peak angle of a relative luminous intensity in the light distribution reaches the diffusion-and-reflection surface at a position in a region at a distance of ¼ to ¾ from a center of the one of the adjacent two light-emitting devices in a center-to-center region of the two adjacent light-emitting devices.

7. A display apparatus comprising:
the surface light source device according to claim 5, and
a display member configured to be irradiated with light emitted from the surface light source device.
